(19) United States
(12) Patent Application Publication
(10) Pub. No.: US 2005/0116057 A1
(43) Pub. Date: Jun. 2, 2005

(54) Novelty beverages straw

(76) Inventor: Douglas Taylor Hamer, Greenville, SC (US)

Correspondence Address: John B. Hardaway, III;NEXSEN PRUET JACOBS & POLLARD, LLC, P.O. Box 10107, Greenville, SC, 29603, US

(21) Appl. No.: 10/725,786

(22) Filed: Dec. 1, 2003

(51) Int. Cl. E03B 9/20; A61J 15/00; A47G 21/18

(52) U.S. Cl. 239/16; 239/33

(57) ABSTRACT

A novelty item for parties and other amusement which is a straw containing a jellied shooter, a granita or a slush. Preferably the jellied shooter, the granita or slush contains a potable alcohol. Alternative embodiments incorporate a holder for multiple straws which may be operably connected to each other.

### FIELD OF THE INVENTION

This invention relates to novelty or party supplies and in particularly to a straw to be used by two people to share a viscous drink in a humorous and quasi-competitive manner. The most suitable drinks are gelled fruit flavored drinks and granitas or slushes. Alcoholic beverages may be included in the drink.

### BACKGROUND OF THE INVENTION

Numerous party favors or “gag gifts” are available commercially including many various designs for straws. Representative is U.S. Pat. No. 6,062,488 to McCafferty, wherein a straw is run through an “action figure.” Multiple straw designs, such as U.S. Pat. No. 4,699,318 to Donatello et al. allow multiple drinkers to sip from the same container, in this particular case, a pitcher.

Adult parties frequently serve alcoholic beverages and fruit-flavored drinks and shooters and are particularly popular in the summer and at beach resorts. Tooters shooters, a product of Mango Bottling Company, are a good example of pre-packaged fruit-flavored shooters.

Granitas and the related sorbets and gelatos are frozen Italian-originated desserts which can be flavored with fruit, wine, or coffee and have become increasingly popular with the development of machines that continuously mix and chill the ingredients. As a dessert, they may be served in a cup. U.S. Pat. No. 4,900,158 is representative of such a machine. U.S. Pat. No. 4,986,994 discloses one recipe for preparing a low calorie version of such a drink, which is commonly sold in English speaking countries as a “slush” drink. U.S. Pat. No. 6,511,693 discloses such a slushy drink in a flexible bag-like container.

Jellied “shooters” made from a gelatin such as Jell-O™, water, and occasionally beverage alcohol in place of some of the water, are popular in bars. They may be cast as a slab and sliced or poured into a cup which serves as a mold. Without the beverage alcohol, they are enjoyed by children.

### BRIEF SUMMARY OF THE INVENTION

It is an object of this invention to combine the flavor and content of a shooter with the pleasant mouth feel of a gelatin, granita or slush, and to dispense the combination in a straw.

It is a further objective of the invention to adapt such a straw to a party game such that two or more people may use the straw at the same time.

### BRIEF DESCRIPTION OF THE DRAWINGS

FIG. 1 shows a first embodiment of the invention in the form of a single drinking straw.

FIG. 2 shows two people sharing a single straw.

FIG. 3 shows a double straw.

FIG. 4 shows a three-way straw.

FIG. 5 shows an alternative embodiment of the straw.

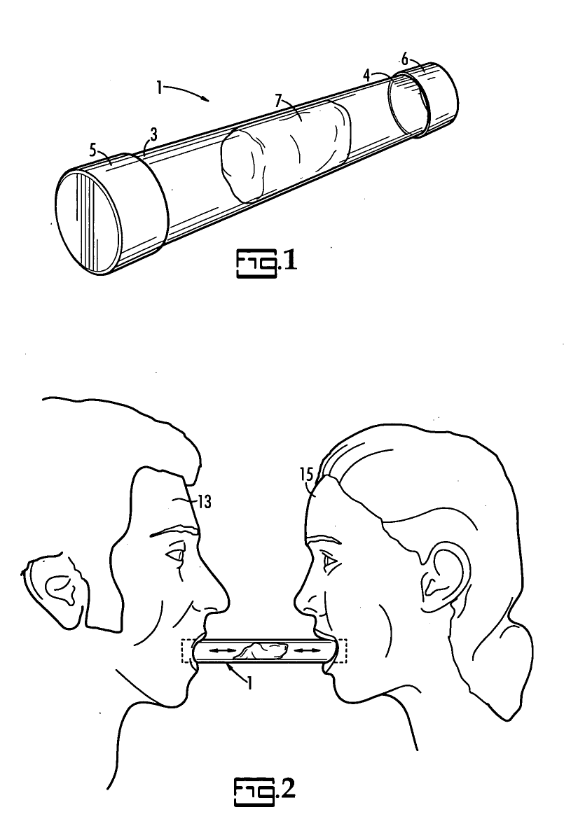

### DETAILED DESCRIPTION OF THE INVENTION

The particular composition of the gelatin, granita or slush used in this invention is not critical except that the components should not be adversely affected over time by light or oxygen. Furthermore, the gelatin or slush must be formed at the typical operating temperatures of the refrigerator compartment or freezer compartment of a typical household refrigerator. Beverage alcohol (ethyl alcohol) is not required as a component but may be preferred by adults.

The straw (1) according to this invention is formed from a straw body 2 having ends 3 and 4. Tightly sealing caps 5 and 6 enclose the end. In consideration of the demands for shelf life, preservation of the flavor and compliance with various laws and regulations regarding the sale of alcoholic beverages, the caps 5 and 6 must adhere tightly and be secured with a breakable seal which is only broken by the ultimate purchaser.

The gelatin, granita or slush 7 fills the center bore of the straw.

Straw 2 must be formed from a semi-rigid food grade plastic such as polyethylene, polyvinyl chloride, polyethylene terephthalate (PET) or polypropylene so that the straw maintains a rigidity characteristic of a conventional cellulosic straw but is flexible and deformable sufficiently to kneed of the slush when the straw is removed from a freezer. Food grade PET is preferred. The end caps 5 and 6 may be made from a hard or soft food grade plastic, preferably one that can be heat sealed or attached to the straw with an adhesive during manufacturing.

The straw is envisioned for a “game” when two people insert their respective straw ends into their mouths after the caps have been removed and either try to suck the contents away from the other person or pneumatically push the contents under pressure into the mouth of the other party.

One typical straw would have an I.D. of 0.5 inches (12.7 mm) and a length of approximately 12 inches (304 mm). Such a straw would have a volume of about 25 ml.

A larger straw with a 50 ml capacity may haven an I.D. of 0.75 in. (19 mm), a wall thickness of 0.022 in. (0.56 mm) and a length of 5.5 in. (140 mm). The straw may be sold in appropriate stores and entertainment venues as a preloaded product for a single use. Empty straws may be reloaded by the user with various blends of jellied shooter mix using any recipe which uses a gelatin to obtain consistency. Warm jellied mix or slush mix may be poured into the larger I.D. straw with or without a funnel or syringe and cooled to a suitable temperature.

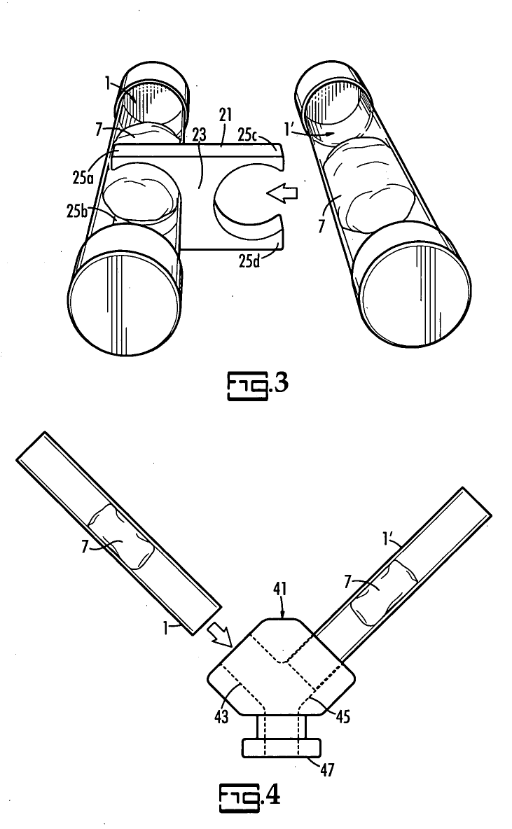

FIG. 2 shows the straw 1 being used by two people 13 and 15.

FIG. 3 shows an arrangement for a “double barrel” straw wherein straws 1, 1′ are connected by a holder 21 having a base portion 23 from which flexible projections 25a, 25b, 25c and 25d project to hold two straws in place. The holder 21 may be integral with two straws but in the preferred embodiment it is detachable and reusable. The “double barrel” straw may be used serially and not require the users to get another straw.

FIG. 5 is an alternative embodiment wherein the cap 5 has been replaced by an inserted plug 5′. A constant diameter tube and plug is preferred, even required, for certain automatic filling equipment.

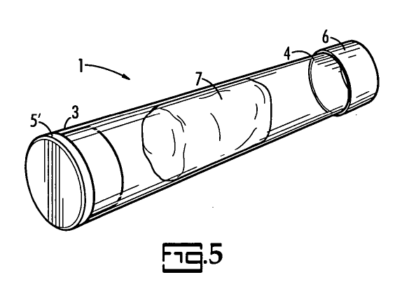

FIG. 4 employees a “Y” shaped holder 41 with sockets 43, 45 into which straws 1, 1′ may be tightly inserted. A mouthpiece 47 is grasped by the third party. An alternative design replaces mouthpiece 47 with a socket so that a third straw may be used. Open pathways connect the sockets so that the Y shaped holder is a connector for the straws.

The invention has been described in terms of a party straw device used by two people. Alternative designs for three or more people are readily envisioned.

The invention has been described in terms of its preferred embodiments and improvements as may be obvious to one of skill in the art are included within the scope of the invention.

1. A flexible straw substantially filled with a flavored material selected from the group consisting of jellied drinks, granitas, slushes, and precursors thereof, said straw having tightly fitting end caps.

2. A straw according to claim 1 wherein the straw is formed from a flexible material selected from the group consisting of polyvinyl chloride, polyethylene, polyethylene terephthalate and polypropylene.

3. A straw according to claim 1 wherein the flavored material is a slush.

4. A straw according to claim 1 wherein the flavored material is a slush precursor.

5. A straw according to claim 1 wherein the flavored material is a jellied drink.

6. A straw according to claim 1 wherein the flavored material is a jellied drink precursor.

7. A straw according to claim 1 wherein the flavored material also includes a beverage alcohol.

8. A straw according to claim 1 which is transparent.

9. A straw according to claim 1 which is translucent.

10. A straw according to clam 1 which is opaque.

11. A holder having a base portion and a flexible projection which hold flexible straws in place.

12. A holder having sockets to hold and connect two or more straws individually.
